(19) United States
(12) Patent Application Publication
(10) Pub. No.: US 2019/0268283 A1
(43) Pub. Date: Aug. 29, 2019

(54) Resource Demand Prediction for Distributed Service Network

(71) Applicant: International Business Machines Corporation, Armonk, NY (US)

(72) Inventors: Sumanta Mukherjee, Bangalore (IN); Krishnasuri Narayanam, Bangalore (IN); Amith Singhee, Bangalore (IN); Nupur Aggarwal, Bangalore (IN)

(21) Appl. No.: 15/903,267

(22) Filed: Feb. 23, 2018

(51) Int. Cl. H04L 12/911; H04L 12/917; H04L 29/08; H04L 12/24; G06F 15/18

(52) U.S. Cl. CPC H04L 47/823; H04L 47/76; G06F 15/18; H04L 67/1008; H04L 41/0654; H04L 47/746

(57) ABSTRACT

Methods, systems and computer program products for resource demand prediction are provided herein. A computer-implemented method includes obtaining historical data logs for activities performed in a distributed service network, the distributed service network comprising a plurality of locations. The method also includes identifying factors influencing resource demand for the distributed service network, determining one or more constraints for specifying activity sequence ordering for activities performed in the distributed service network and generating a statistical model of the distributed service network utilizing the historical data logs, the identified factors and the determined constraints. The method further includes utilizing the statistical model of the distributed service network to determine estimated resource demand for responding to one or more detected outages in the distributed service network, the estimated resource demand being used to allocate resources to the plurality of locations in the distributed service network to respond to the one or more detected outages.

### FIELD

The present invention relates to resources, and more specifically, to techniques for predicting resource demand.

### BACKGROUND

Distributed service networks, such as utilities, telecommunications networks, distributed computing infrastructure, etc. may include multiple geographic locations. When there is an outage or other event in a distributed service network, there is a need to schedule tasks for responding to the outage or other event. Scheduling tasks, however, requires accurate resource demand prediction at different locations in the distributed service network.

### SUMMARY

Embodiments of the invention provide techniques for resource demand prediction for distributed service networks.

In one embodiment, an exemplary computer-implemented method comprises steps of obtaining historical data logs for activities performed in a distributed service network, the distributed service network comprising a plurality of locations, identifying factors influencing resource demand for the distributed service network, determining one or more constraints for specifying activity sequence ordering for activities performed in the distributed service network, generating a statistical model of the distributed service network utilizing the historical data logs, the identified factors and the determined constraints, and utilizing the statistical model of the distributed service network to determine estimated resource demand for responding to one or more detected outages in the distributed service network, the estimated resource demand being used to allocate resources to the plurality of locations in the distributed service network to respond to the one or more detected outages. The steps are carried out by at least one computing device.

In another embodiment, an exemplary computer-implemented method comprises steps of detecting one or more outages in a distributed service network comprising a plurality of locations, estimating amounts of the detected outages at each of the plurality of locations in the distributed service network, obtaining information related to external factors affecting the detected outages at each of the plurality of locations in the distributed service network, utilizing a statistical model of the distributed service network to determine estimated resource demand for responding to the detected outages in the distributed service network, and allocating resources to the plurality of locations in the distributed service network to respond to the detected outages based at least in part on the estimated resource demand. The steps are carried out by at least one computing device.

Another embodiment of the invention or elements thereof can be implemented in the form of an article of manufacture tangibly embodying computer readable instructions which, when implemented, cause a computer to carry out a plurality of method steps, as described herein. Furthermore, another embodiment of the invention or elements thereof can be implemented in the form of an apparatus including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a utility system, according to an exemplary embodiment of the present invention.

FIG. 2 depicts relationships between events, tasks, activities, effort and internal and external variables, according to an exemplary embodiment of the present invention.

FIG. 3 depicts a flow for estimating activity effort, according to an exemplary embodiment of the present invention.

FIG. 4 depicts a flow for sequence modeling of tasks and activities, according to an exemplary embodiment of the present invention.

FIG. 5 depicts a flow for model evaluation ordering, according to an exemplary embodiment of the present invention.

FIG. 6 depicts a flow for automated data partitioning, according to an exemplary embodiment of the present invention.

FIG. 7 depicts a resource demand prediction system, according to an exemplary embodiment of the present invention.

FIG. 8 depicts a flow for estimation of response variables, according to an exemplary embodiment of the present invention.

FIG. 9 depicts a process for generating a statistical model of a distributed service network, according to an exemplary embodiment of the present invention.

FIG. 10 depicts another process for estimating resource demand in a distributed service network utilizing a statistical model, according to an exemplary embodiment of the present invention.

FIG. 11 depicts a computer system in accordance with which one or more components/steps of techniques of the invention may be implemented, according to an exemplary embodiment of the invention.

FIG. 12 depicts a cloud computing environment, according to an exemplary embodiment of the present invention.

FIG. 13 depicts abstraction model layers, according to an exemplary embodiment of the present invention.

### DETAILED DESCRIPTION

Illustrative embodiments of the invention may be described herein in the context of illustrative methods, systems and devices for resource demand prediction. However, it is to be understood that embodiments of the invention are not limited to the illustrative methods, systems and devices but instead are more broadly applicable to other suitable methods, systems and devices.

As discussed above, there is a need for accurate resource demand predictions in distributed service networks for efficient response to outages or other events affecting services provided using the distributed service network. Accurate resource demand prediction is a complex and involved modeling activity. Techniques are needed for catering to uncertainty and providing robust probabilistic models for resource demand prediction with low variance to provide real-time task scheduling functionality for a distributed service network.

Various embodiments are described herein primarily with respect to responding to or remediating service outages, such as service outages associated with a utility, due to some event. In some cases, tasks are associated with responding to or remediating service outages of a utility distribution network (e.g., an energy utility, a water utility, etc.) due to some event such as a natural disaster (e.g., a storm, earthquake, fire, etc.) or other disruption of service. In such cases, the resources may represent assessment and repair crews, equipment, etc. needed to respond to or remediate the service outages. In other cases, tasks may be associated with responding to or remediating service outages of another type of distributed service network (e.g., a telecommunication network, a distributed computing system, a “smart” city, etc.) in response to some event (e.g., a natural disaster, infection with a virus or other disruption due to malware, widespread equipment failure, recalls, etc.). In such cases, the resources may represent maintenance and repair staff, equipment, etc. needed to respond to or remediate the service outages. Various other use cases are possible. More generally, tasks may be associated with service outages of any geographically distributed service network due to some event such as a natural disaster, and the resources may be maintenance and repair staff, equipment, etc. responsible for restoration of the outages.

Distributed service delivery operation often suffers service disruptions due to natural or technical causes. A quick response to restore services is crucial for uninterrupted business need. Restoration strategies can be reactive or proactive in nature. Proactive planning can advantageously help to achieve quicker restoration time. Generally, proactive planning includes three components: (1) damage prediction; (2) demand prediction; and (3) resource allocation or positioning. Systems described herein are primarily focused on demand prediction, which may be used to set or modify resource allocation or positioning as will be described in further detail herein.

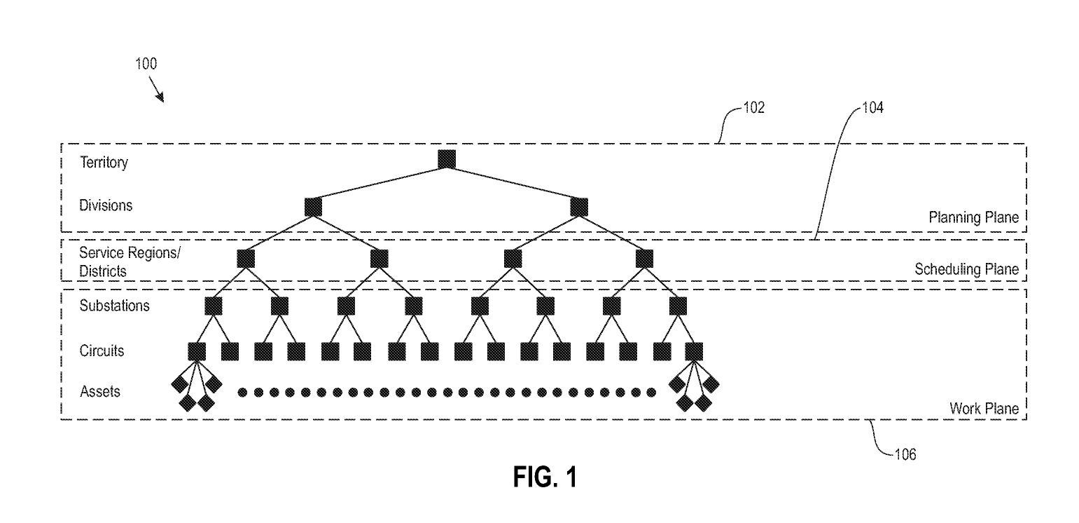

One exemplary use case, as mentioned above, is in the context of a utility such as an electricity distribution utility. FIG. 1, for example, depicts a utility system 100 organized into a planning plane 102, a scheduling plane 104 and a work plane 106. The planning plane 102 includes a territory and multiple divisions, and is configured to manage staffing levels across multiple service regions in the scheduling plane 104. The planning plane 102 is also configured to manage resource allocation across the service regions, as well as handle mutual aid and contractor decisions for resource allocation.

The scheduling plane 104 includes multiple service regions or districts, also referred to herein as service centers. The scheduling plane 104 is configured, within each of the service regions, to coordinate work order scheduling, job packet creation, job dispatch, job monitoring, etc. In some embodiments, the scheduling plane 104 may be implemented as an IBM® Maximo® Scheduler, part of the Maximo® Asset Management solution available from International Business Machines Corporation.

The work plane 106 includes, as part of the different service regions or districts, multiple substations, circuits, and assets. The work plane 106 is configured to coordinate maintenance and restoration activities for the utility 100, such as field crew enablement, operational support, etc. In some embodiments, the work plane 106 may be implemented as an IBM® Maximo® Anywhere solution part of the Maximo® Asset Management solution.

FIG. 1 illustrates the utility 100 logically as a tree hierarchy, with distributed assets represented as leaf nodes in the work plane 106. At the top level of the tree hierarchy is divisions and territories in planning plane 102, where resource allocation and planning decisions are made.

Functionality of the planning plane 102 will now be described with respect to a scenario involving a restoration work plan for the utility 100 created in response to a predicted natural disaster or other emergency event. The planning plane 102 may utilize a weather forecast, for example, to identify the characteristics, path, timing and severity of an incoming weather event. Utilizing the weather forecast, the planning plane 102 may perform damage and outage predictions, such as predicting damages and/or outages expected to occur in the different divisions, service regions, substations, etc. per day, shift or other unit of time, per damage type. Based on the damage and outage predictions, the planning plane 102 can generate resource demand predictions. The resource demand predictions may be used to determine how many tasks are expected in each division, service region, substation, etc. per task type per day, shift or other unit of time. The resource demand predictions may further comprise predictions of the distribution of task duration and travel times for moving or re-allocating resources from one division, service region, substation, etc. to another.

The planning plane 102, utilizing the damage and outage predictions as well as the resource demand predictions, generates one or more resource positioning configurations. The resource positioning configurations, in some embodiments, are designed to optimize: (i) staffing levels across multiple service centers to meet expected and outstanding resource demands; (ii) resource reallocation across service centers; (iii) mutual aid and contractor decisions; etc. The planning plane 102 in some embodiments is configured to generate the resource positioning configurations to provide real-time planning in emergencies, to provide stochastic resource deployment policies, taking into account forecast and realized demand with priorities, etc. Additional details regarding generating resource positioning configurations are described in U.S. patent application Ser. No. 15/882,404, filed Jan. 29, 2018 and entitled “Resource Position Planning for Distributed Demand Satisfaction,” which is commonly assigned herewith and incorporated by reference in its entirety.

Embodiments provide various techniques for implementing resource demand prediction. Going from an outage (realized or predicted) to an accurate resource demand prediction is an involved modeling activity. Catering to the uncertainty and robust probabilistic modeling with low variance is desired to provide useful real-time task scheduling activities.

Various real-life distributed service networks and other systems exhibit variability in performance when repeating tasks. For example, weather prediction and damage estimation systems may involve uncertainty or variability in final response variables. The final response variable may represent total resource demand. Such variation may be categorized into two classes, intrinsic and extrinsic. Extrinsic variation can be explained by the influence of external factors. Unexplained variation is intrinsic variation, which may be inherent to the distributed service network or other system for which resource demand predictions are desired.

The restoration process for a distributed service network or other system may involve multiple sequential and parallel activities. Each of the activities may exhibit variability, such as in its associated resource demand. Sequences of activities are often non-deterministic in nature. For example, in electrical utility restoration work, the associated tasks may be of different types such as assessment and repair. The sequence of tasks associated with any particular outage restoration can involve: (i) only an assessment task; (ii) an assessment task followed by a repair task; (iii) an assessment followed by multiple repair tasks; (iv) one or more repair tasks which initiate or prompt one or more assessment tasks; etc.

As mentioned above, factors that influence variability in systems may be intrinsic or internal to the system, e.g., the value of a variable may be unknown until an event has occurred. Knowledge of such variability may be captured as a hypothesis, such as by an expert in the field. For each such proposed hypothesis, a specialized statistical model can be implemented. Such modeling activities, however, are very specific to an associated distributed service network or system, and cannot be easily generalized to other distributed service networks or other systems.

With the arrival and adoption of various technology, digitized event log histories for distributed service networks and other systems are made readily or easily available. Statistical dependencies between various factors and response variables can be discovered by applying advanced statistical techniques on such historical logs. An understanding of uncertainties, or an estimate of a most likely sequence of observable tasks with associated demand, is important from a resource management point of view. Techniques for generating resource demand predictions taking into account such uncertainties are needed, to help organizers and planners of systems such as distributed service networks to come up with effective event management plans.

Resource demand and performance forecasting are used in various industrial applications, including retail store supply chain sales forecasting, activity based travel analysis, weather driven multi-category infrastructure impact forecasting, contact center behavior forecasting, etc. Some approaches seek to address an effort and demand estimation process as fixed, or using averages. Approaches are needed which address the variability and uncertainty associated with resource effort predictions.

Multiple activities may be required to complete a task. Each of such activities, however, may have a specific modus operandi, which is affected by a different set of external factors. Analyzing the influence of different factors on aggregate effort can introduce large margins of error. Some embodiments provide techniques for modeling which aggregate at an activity resolution to produce effort estimations. Influence of different factors, internal and external, may be statistical in nature leading to uncertainty associated with estimated effort. Some embodiments thus provide techniques for modeling which produce effort estimates with uncertainty associations.

There is a further need for producing activity and task sequences from a total event or outage volume. Some embodiments use generative models to estimate the sequence of activities or tasks with uncertainty measures.

Embodiments may provide a data driven self-sustained automated system configured to mine statistical models that best describe and account for data variability and produce robust resource demand prediction for forthcoming issues (e.g., predicted and realized events). Process-specific details can be input to such a system using metadata information, such as via configuration files. Historical logs are utilized for learning. Logs in some embodiments provide timestamps for each activity, and related factors and associated internal and external variable information. Approaches described herein may be viewed as operating in two phases. In a first phase, process-specific metadata and time logs for historical events is read and analyzed to generate: (i) a model file that describes a variable dependency tree; and (ii) statistical models for each of the internal and response variables. In a second phase, the model files are read to generate resource demand forecasts or predictions.

Embodiments may utilize various input, such as input logs of past events, metadata containing associated internal and external factors for different activities, estimated numbers of issues or events for particular time intervals and particular locations with external parameter associations, etc. The input logs, in some embodiments, have time-stamped start and end points for different activities. The metadata may vary based on use case. For example, in the case of an electrical maintenance utility the metadata may include, for damage associated with an electrical device, a location, time, weather condition, etc. A generated list of activities may be output, with internal or modeled parameters and expected resource demand.

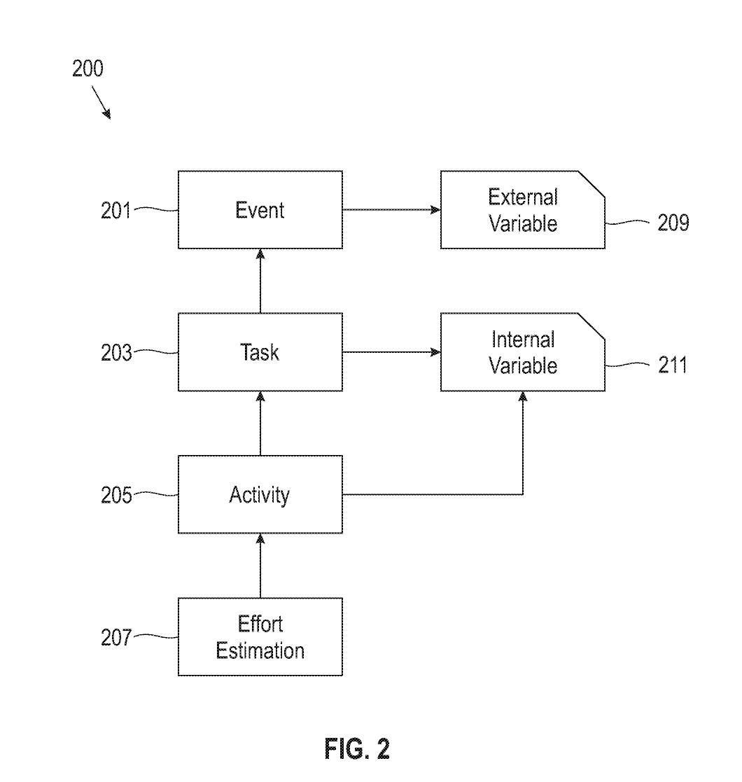

FIG. 2 depicts an overview 200 of relationships between events 201, tasks 203, activities 205, effort estimation 207, external variables 209 and internal variables 211. An event 201 is the top level abstraction of demand modeling. An event is composed of one or more tasks 203. External variables 209 are associated with the event 201, and are common across all activities 205 for the event 201. Each task 203 is composed of one or more activities 205. A sequence of activities 205 can be deterministic or stochastic in nature. Internal variables 211 are associated with each task 203 and its corresponding activities 205. The effort estimations 207 represent the time or demand that is associated with each of the activities 205. Total demand at the task 203 level is obtained by aggregating the efforts associated with each of its activities 207. Similarly, the total demand for the event 201 is obtained by aggregating the efforts associated with each of the tasks 203 (which are themselves aggregates of the efforts of their associated activities 205).

Approaches described herein generate probabilistic models, and thus produce likelihoods that are associated with predicted resource demand. The event 201 may represent an incident or issue that initiates restoration, maintenance, and/or organizing activity. In some embodiments, events 201 represent outages. Such an event 201 may be composed of one or many tasks 203. In an example restoration process for an electrical distribution utility, the outage restoration or event 201 may involve multiple assessment or repair type tasks 203, with each of the tasks 203 involving multiple activities 205. Continuing with the example of an outage restoration event 201 for an electrical distribution utility, the activities 205 may include preparation and gathering instruments or other resources for repair work, travel to outage sites, restoration work at the sites, etc. Each of the activities 207 may require effort to complete, such as specific man-hours or other units of effort (e.g., number of resources such as computing time, memory or storage, network resources, etc.). There are various factors at each level. For example, in the outage restoration event 201 for an electrical distribution utility, factors may include geo-location, weather conditions, etc. Each of the tasks 203 may be associated with particular types of resources and equipment associated with the outage or other event 201.

Tasks 203 may be viewed as the work carried out by a unit resource when assigned to an event 201. Again continuing with the example of an outage for electrical distribution utility, an event 201 may be a broken pole causing a power outage, with tasks 203 including a set of assigned resources of different types (e.g., tree-cutting personnel and equipment, assessment personnel, repair crew and parts needed, etc.). The activities 205 may be viewed as the set of unit processes involved in carrying out a task 203, such as travel and repair activities 205 for each task 203.

External variables 209 are variables that are external to the process but associated with event 201. Examples of external variables include location, month or time of year, time of day associated with each outage, etc. The external variables 209 are associated with the event 201, and are common across all tasks 203 and activities 205 of that event 201. Internal variables 211 are those that are closely associated with the process, and knowledge of the internal variables 211 may be unknown until their realization. Examples of internal variables 211 include resource assignment, outage types, outage severity, etc. The internal variables 211 are associated with each task 203 and its associated activities 205. The nature of the activities 205 and tasks 203 are internal variable 211 dependent. Resource demand is attributed to the activities 205, and the resource demand for each activity 205 can be dependent on both external variables 209 and internal variables 211.

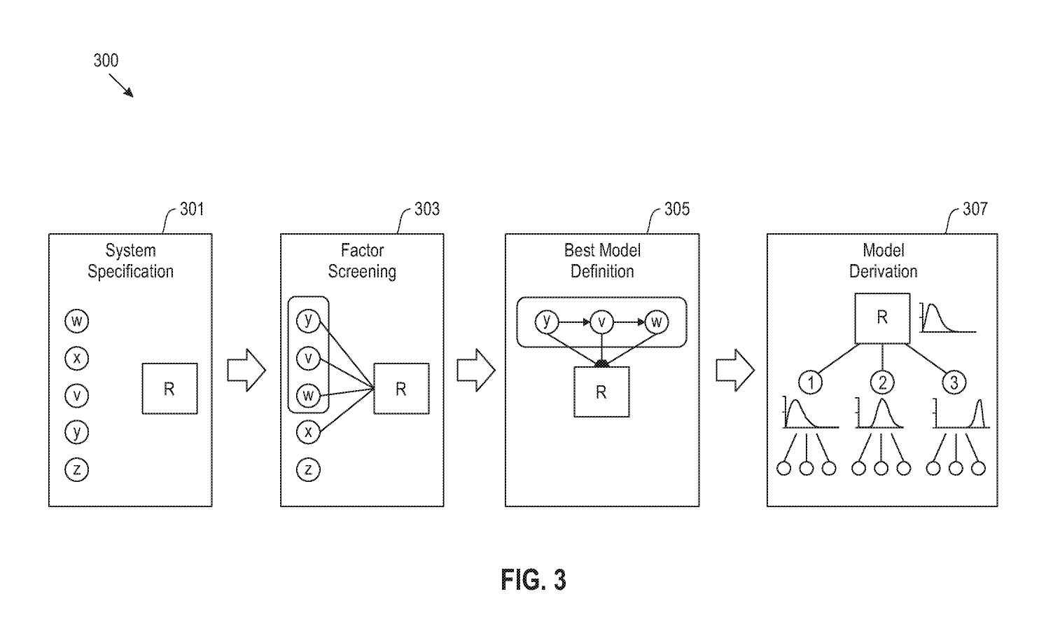

Embodiments provide techniques for accurate estimation of resource demand, at activity resolution, for a distributed service network or distributed service delivery system given activity types, internal and external factors or variables, mappings between task types and activities, and historical data of activity efforts. Techniques used in some embodiments may involve four components or phases: (1) activity effort estimation; (2) sequence modeling; (3) model evaluation ordering; and (4) automated data partitioning. Each of these components will be described briefly below, before an in-depth discussion of each of the components (1)-(4) with respect to FIGS. 3-6, respectively.

The first component is activity effort estimation, where a hierarchical prediction model is created for the effort for each valid combination of task type and activity type. The hierarchical prediction model may be created by computing association scores between internal factors and effort, filtering out a subset of the internal factors based at least in part on the association scores, ranking the internal factors (e.g., in decreasing order of their association score), and partitioning the data hierarchically by these internal factors (e.g., in the decreasing order). A distribution model is learned for the effort variable at the nodes of the hierarchy. The distribution model in some embodiments is learned using Bayesian statistics to generate a hierarchical Bayesian model (HBM). Additional details regarding activity effort estimation will be provided below in the discussion of FIG. 3.

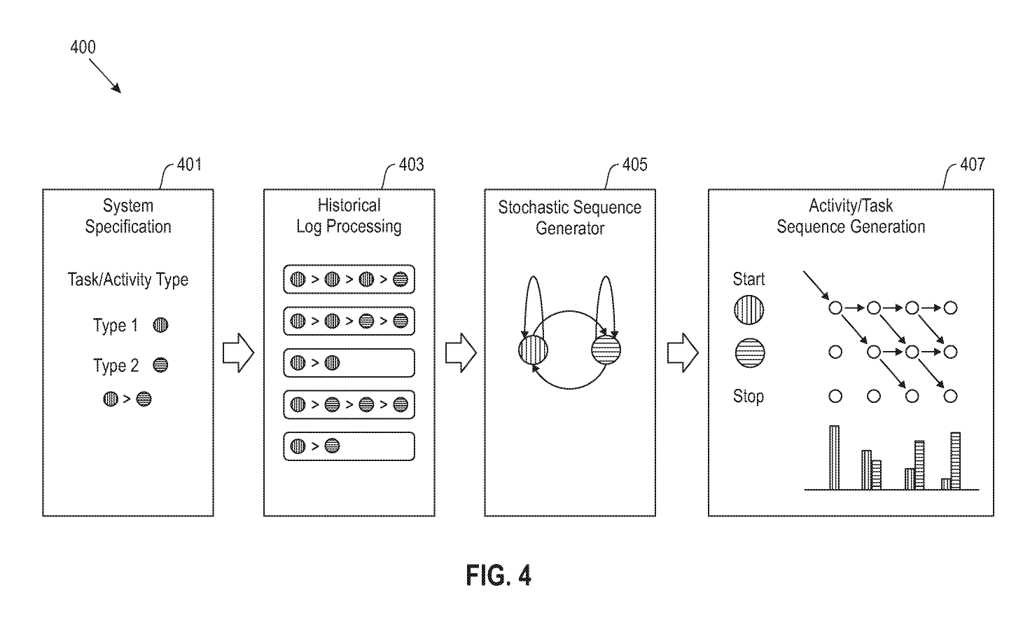

The second component is sequence modeling, where task sequence models are created by specifying task dependencies, creating a stochastic state transition model for task sequences which honor the specified task dependencies with unknown or default transition probabilities. The default transition probability in some embodiments is set to 0, although other values may be used as desired. The transition probabilities are then learned from the historical data. Additional details regarding sequence modeling will be provided below in the discussion of FIG. 4.

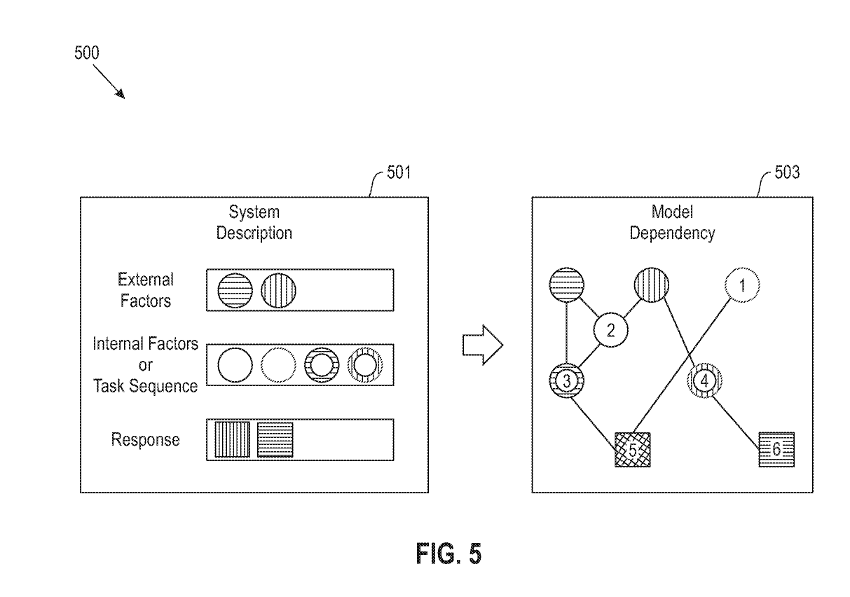

The third component is model evaluation ordering, where a generative model for effort estimation is computed by ordering internal factor models in a topological order. Each internal factor is evaluated, respecting the topological dependent order, if that internal factor is not observed in the given data. Internal factors are attributes dynamically associated with the service, e.g., actual attribute association is only known at the time of execution. As an example, an outage might be evaluated as an activity of type assessment. But during the progress of that assessment activity, it might be possible to discover that a subsequent repair activity also has to be associated with this outage. As another example, for an aggregated outage prediction, the outage types are often not known at the time of demand estimation. Using statistical models derived from historical data, the system decides the outage type associated with each outage. For an electrical distribution utility, outage types may be associated with device types, such as fuses, circuit breakers, transformers, etc. In this case, the outage type is an internal factor. All of the internal factors are evaluated until the effort estimation is evaluated. Additional details regarding model evaluation ordering will be provided below in the discussion of FIG. 5.

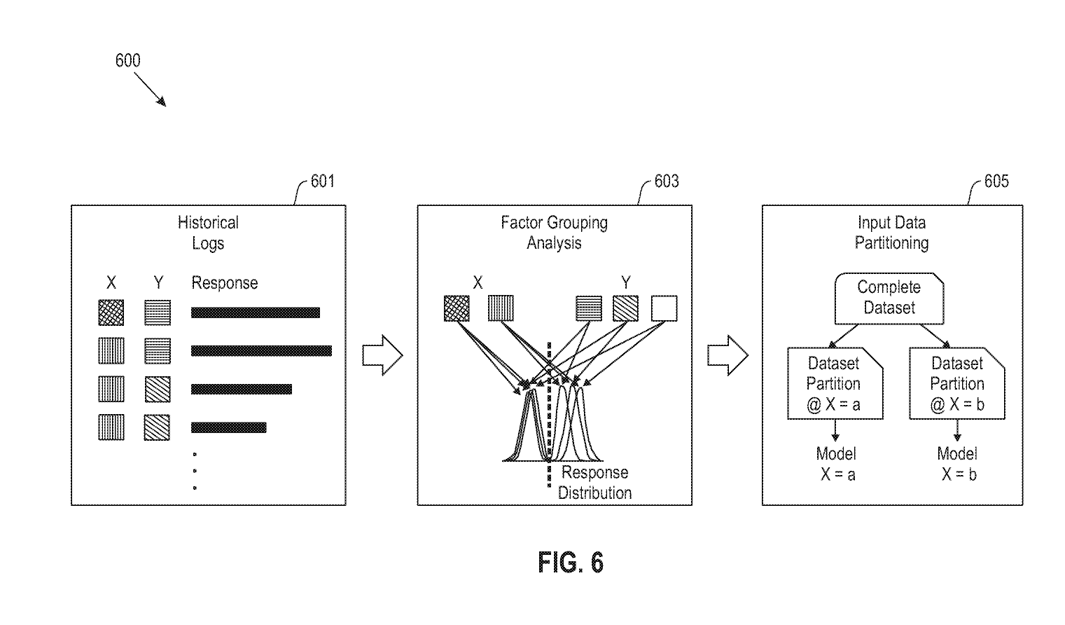

The fourth component is automated data partitioning, where the data is segregated into partitions such that each data partition represents a distinct operational condition. The processing of the first, second and third components described above may be applied on each data partition separately. Data segregation may be performed, for each task type to activity type combination, by associating factors as given in the historical data. For each selected factor with a strong influence on effort estimation, pairwise data partitioning is performed, and on each such data partition effort estimation distribution is calculated. Factors which have an extreme effect on the effort estimation distribution are identified, and the input data is partitioned on each of such factors. Additional details regarding automated data partitioning will be provided below in the discussion of FIG. 6.

FIG. 3 depicts a flow 300 for estimating activity effort. During system specification 301, internal and external factors are listed for each response variable (e.g., demand metric). The list of internal and external factors may be provided at the time of training. As shown in FIG. 3, the list of factors includes factors denoted w, x, v, y and z, and the response variable is denoted R.

In factor screening 303, the historical data is read in a tabular format and the statistical association of each factor to the response variable is evaluated. The statistical associations between response variables and factors are estimated using mutual information content. For a linear system, the information content may be equivalent to a correlation coefficient. In an electrical distribution utility, example response variables are resource travel time, response time and work time, while location, time of the year, and weather conditions are prospective factors. Using the extent of association, the top few factors are screened for further modeling. As shown in FIG. 3, the top factors screened for further modeling include factors y, v and w. It is to be appreciated, however, that embodiments are not limited to selecting three factors for further screening. In some embodiments, a top N factors are selected for further screening, where N may be greater or less than three. In other embodiments, each factor having an association greater than some designated threshold may be selected for further screening. Some embodiments may also use combinations, such as all factors having an association greater than a designated threshold, subject to a minimum and/or maximum number of factors being selected for further screening.

Lists of internal and external factors, as well as task and activity definitions, may be used for training. Historical data, as mentioned above, may be read in a tabular format where rows in a table capture the information related to effort associated with a particular activity. Each row or entry in the table may also report the association of different factors with a given activity. Such information may be utilized to analyze the extent of influence of each factor on one or more response variables such as associated effort. The extent of influence of a given factor may be captured as the mutual information of the factor to the associated effort. The factors may be ranked by the extent of their association to each activity.

In best model definition 305, a rank order association of different factors with the response variable is derived. This rank order relation may be used as a base model description. In FIG. 3, the ranked ordering of factors is shown as y→v→w for response variable R.

In model derivation 307, the ranked order of factors is used to partition the data space hierarchically. At each node, statistics are derived using a parent node as prior (e.g., using Bayesian statistics). Each level of the hierarchy splits the data by a specific factor value. The parent node statistics are the marginal distribution of the factor. The hierarchical partitioning is depicted in 307, and 1, 2, 3 are roots of sub-partitions at each level. The derived distribution over response variables at each sub-partition using hierarchical Bayesian statistics are depicted in the graph in 307. This hierarchical splitting of data using priors to derive child node statistics helps to produce robust statistics, even with an unbalanced training data distribution over different factors. In some embodiments, other types of sophisticated modeling may be used in place of a hierarchical Bayesian model. For example, deep leaning models can be employed if there is a large volume of historical data with rich information content available. When there is not enough training data, other types of modeling may be used in place of the hierarchical Bayesian model.

Embodiments may provide for data driven model discovery, carried out at the training of models during the automatic model discovery. As a training model specification, lists of factors (e.g., external factors) may be provided during system specification 301. The list of factors may be user-supplied. For each activity effort estimation, the factor association with the observed effort is evaluated. Given a set of factors and historical data of factors-to-effort associations, influencing factors can be automatically discovered and ordered to ensure robustness of effort estimation.

A set of factors are selected for model building in factor screening 303. The selected set of factors may be a minimum set of factors that best explain the observed variation in effort. Depending on the extent of influence of the selected factors and their causal dependency, the selected set of factors may be ordered in best model definition 305. The factor ordering may be used to describe the HBM that is derived in model derivation 307. The final derived model may hold descriptions of effort distribution as a conditional probability for all influential factor combinations. This is obtained by hierarchical partitioning of data, as per the order dependence. For each partition the distribution is derived, considering the distribution of the parent node as prior.

FIG. 4 depicts a flow 400 for sequence modeling of tasks and activities. In system specification 401, types of valid task sequences are specified. For example, FIG. 4 shows two task types denoted Type 1 and Type 2, as well as a valid ordering. The stochastic sequence order may be explicitly provided during system specification 401. Similar sequence modeling techniques may be employed for activity sequence modeling.

Historical log processing 403 provides preprocessing of historical log data, to filter out activity/task rows which defy the order restriction imposed in the system specification 401. Activity and task ordered sequences may be generated using timestamps and event or outage identifiers (IDs).

In stochastic sequence generator 405, a sequence generator Markov process is defined, by inserting a start state and absorbing stop state. Transition probabilities are obtained using the historical logs. The transition probabilities capture the likelihood of generating a particular task sequence, which is learned from the historical data. It is to be appreciated that embodiments are not limited solely to use with Markov sequence generator processes. Various other types of sophisticated sequence generation techniques can be employed, such as Hidden Markov Model, Long Short Term Memory Network model, etc.

In activity/task sequence generation 407, the stochastic sequence generator is used to generate expected numbers of task sequences. Data driven task and sequence generation is used to model finite state sequences, with the sequence generating Markov model introducing two auxiliary states (start and end/stop). From the historical event logs, the sequence order is derived using unique event ID, and activity or task timestamps. The Markov model is trained on the observed sequences. The effect of different factors on the derived model may also be evaluated, to identify influencing factors thereby generating a distinct model for different conditional partitions. For example, from FIG. 407 possible task sequences include: (i) Start→Type 1→Type 2→Stop; (ii) Start→Type 1→Type 1→Type 2→Type 2→Stop; etc. All possible sequences with the imposed order restriction as mentioned in the input specification can be generated from this task generator.

In some embodiments, as discussed above, Markov chains are used for task and activity sequence modeling. Each task may be viewed as a resource assignment to carry out a particular type of work, and activities are actions involved in carrying out a task. Factors influencing Markov sequence generation may be automatically identified, to produce a conditional model of each of the factors. For each solved activity, a separate HBM may be learned as discussed above.

Sequences of tasks and activities may be modeled as Markov chains. For task modeling, Markov transition matrices are used to encode the probability chance of observing a particular sequence of tasks. The model may also add extra states, such as start and stop states, to model the finiteness of each task sequence. Activity modeling may be performed in a similar manner for each task. The transition matrices may be learned from historical data. As stochastic Markov chains are more expressive compared to finite state automata, both uncertainty and fixed task and activity structure may be encoded in this modeling framework. The model may be used to generate predictions as expected sets of task and/or activity sequences using the Markov transition matrices for a given set of estimated events.

FIG. 5 depicts a flow 500 for model evaluation ordering. In system description 501, internal and external factors are defined, along with response variables. The internal factors can be directly associated with task or activity generator models. In model dependency 503, an implicit ordering of internal factor modeling, activity/task sequence modeling and response variable estimation is imposed. This scheme allows for uniquely defining the topological order of variable evaluation. Respective models are sequentially invoked in the order specified by model dependency 503. In the case of partially observed data, nodes with observed variables are used as is, and respective model invocation is skipped in the computation graph for those instances.

The computational graph shown in model dependency 503 of FIG. 5 captures the order dependence between different model evaluations, and allows handling partially observed data. Multiple models may be derived for different effort estimation, as well as for internal variable modeling. Internal variables are often directly associated with task or activity type. For example, in an electrical utility context, an assessment or repair type of task is considered as an internal factor which is directly associated with the task generator model. Model evaluation order constraints may be imposed, such as an ordering constraint of external variable→internal variable→sequence generator model→effort estimation. The model dependencies and imposed evaluation order constraints uniquely resolve the model evaluation order, which may be saved as a computation graph. In cases of partially observed data, node values may be directly retrieved from the observation, skipping the corresponding model execution.

In some embodiments, systems are configured to derive internal factor ordering using factor dependency trees. Factor ordering may be used to ensure that the internal factor value estimate is available before the factor value is needed in the model. The ordering of factors may be obtained using a topological sort. In order to guarantee that there exists a valid sorted sequence, the system may impose dependency constraints to ensure that the resulting dependency graph has no cycle.

Subsystems may have different operational characteristics, leading to a large variation across performance metrics such as associated effort. In some embodiments, systems are configured to automatically identify data partitions that segregate distinct operational characteristics. Identification may involve or utilize unsupervised learning. Distinct models may be derived for the disjoint data partitions for improved effort estimation.

If there are multiple statistical models from which observed data are obtained, pooling the dataset together may introduce high bias in a resulting model. Event management may involve distinct class operatives and operational directives for different activity types. Due to changes in the directives and operational modes, the characteristic effort that is associated may vary significantly. This can introduce high prediction bias in the HBM described above.

In some embodiments, the system assumes that model variation can be captured distinctly by some internal and/or external factors. The system may analyze the effect of each factor on the response variable (e.g., effort), and in the process discover clusters of factor value combinations. Response metrics from different clusters may exhibit distinct distributions. Thus, clusters may typically correspond to distinct operation directives or mode.

Once clusters are discovered, the data may be automatically partitioned into distinct bins, with separate models being learned for each of the data bins. Such model segregation reduces the prediction bias of the regularized HBM. Once the model is derived, difference model trees are finally merged together, to generate a final model representation. The final representation may be interpreted in a generic way by the prediction model to produce the final prediction.

FIG. 6 depicts a flow 600 for automated data partitioning. Historical logs 601 are provided in a tabular format. For each response variable, there is factor association as described by the log data. In FIG. 6, X and Y denote factors or factor groups. Factor grouping analysis 603 involves, for each selected factor or factors with strong influence (e.g., influence above a first designated threshold) on response variables, performing pairwise data partitioning. Strong influence is identified via unsupervised learning. If a certain condition affects the operational characteristic of the system, distinct clusters emerge. The system identifies each distinct cluster as a separate partition. On each such data partition, the response distribution is calculated. Variables which have extreme effects (e.g., effects above a second designated threshold) are then identified. Input data partitioning 605 is then used to partition the input data for robust response modeling. The input data set is partitioned on the identified variables which have extreme effects on one or more response variables. Separate statistical models are learned for each partition, as illustrated in FIG. 6 with different models being generated for different values a and b of factor X (or factor group X). For example, in an electrical distribution utility, on major event days (natural disaster days), the operational characteristics are distinct from a normal day. The system automatically identifies these operational conditions from the historical data and partitions the historical data. For each such partition a separate statistical model is learnt.

In some embodiments, identification of different operation characteristics is performed. Effort distribution with multiple modes is a signature of different operational characteristics across sub-systems. The factor grouping analysis 603 identifies factor partitions that best explain this multi-modality. The input data partitioning 605 then partitions the training data (e.g., historical logs) accordingly. For each partition a separate model is trained, which leads to a low variance model definition.

Total effort estimation may be carried out for both unseen events and/or partially observed events, in mid-event scenarios. For partially observed event effort estimation, conservative effort estimates may be produced. Training is used to generate a model that reports all relevant external and internal parameters or factors for the model. The prediction model can read a trained model, which may be represented as a JavaScript Object Notation (JSON) file, and the input outage volume (e.g., in the tabular format described above) for prediction. The model definition is used to find factors that are important for the effort estimation as well as their sequence of dependency.

To perform effort estimation, embodiments may utilize a full detailing of external variables, which may be provided as an input table. Missing internal variables may be incrementally modeled, followed by task and activity estimation. In each step, new columns may be added to the input table, with the new columns corresponding to variables modeled in that step.

When internal variables are partially specified, corresponding modeling steps may be skipped for those entries. In addition, partial specification of task and activity sequences may be handled in a conservative manner as detailed above. The total number of observed events may be aggregated, such as by unique event IDs. Forward prediction can then be performed for task and activity sequences. Correspondence between observed task and activity sequences with predicted sequences are found, such as by maximizing future effort predictions. This may be solved as an assignment problem.

The sequential nature of internal variable modeling allows effort estimation for partially observed internal variables. By imposing conservative constraints, the system can uniquely handle the partially realized event effort estimation.

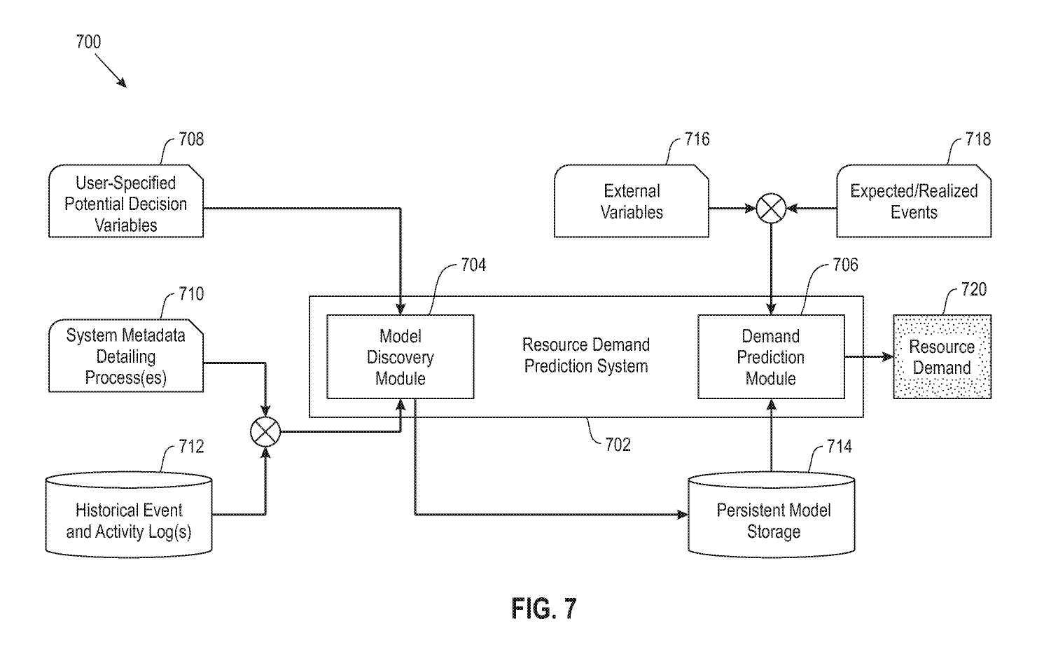

FIG. 7 depicts an information processing system 700, including a resource demand prediction system 702. The resource demand prediction system 702 includes a model discovery module 704 and a demand prediction module 706.

The model discovery module 704 provides training functionality, performing model discovery from historical data using various input. Such input includes user-specific potential decision variables 708, system metadata detailing processes 710 for a distributed service network or system, and historical event and activity logs 712 for the distributed service network or system. This input may be used as described above to derive a model, which is stored in persistent model storage 714.

The demand prediction module 706 utilizes the derived model in the persistent model storage 714, along with information regarding external variables 716 and expected or realized events 718, for scoring to perform resource demand prediction. The demand prediction module 706 provides predicted resource demand 720 as an output.

The resource demand prediction system 702 may be viewed as providing training functionality via the model discovery module 704 and providing prediction functionality utilizing the demand prediction module 706. The model discovery module 704 utilizes available historical data logs to derive a statistical model of a distributed service network. The demand prediction module 706 uses the derived statistical model, for a given volume of estimated outage, to generate an accurate demand forecast for the distributed service network.

As mentioned above, the input to the model discovery module 704 includes user-specified potential decision variables 708. The user-specified potential decision variables 708 may include column names (from historical logs) that are likely to influence response variables (e.g., resource demand). The model discovery module 704 also takes as input system metadata detailing processes 710. The system metadata 710 may describe internal details for a process, such as activity sequence orders. The system metadata 710 may also include mappings of historical log column names to actual process variables. The model discovery module 704 further takes as input historical event and activity logs 712. The historical logs 712 may include historical time logs, such as input logs of past events, with timestamped start and end points for different activities.

The demand prediction module 706 utilizes a derived model of the distributed service network, obtained from persistent model storage 714, to predict resource demand 720. To do so, the demand prediction module 706 utilizes additional input such as information regarding external variables 716. External variables 716 may include current values for various external variables. For example, in electrical maintenance utility outage prediction, external variables may include location, weather conditions, time of year, a total number of utility assets, etc. The demand prediction module 706 also uses information regarding expected and/or realized events 718 as input. Expected and/or realized events 718 may include an estimated number of issues on a given date at a given location, along with associated external parameters.

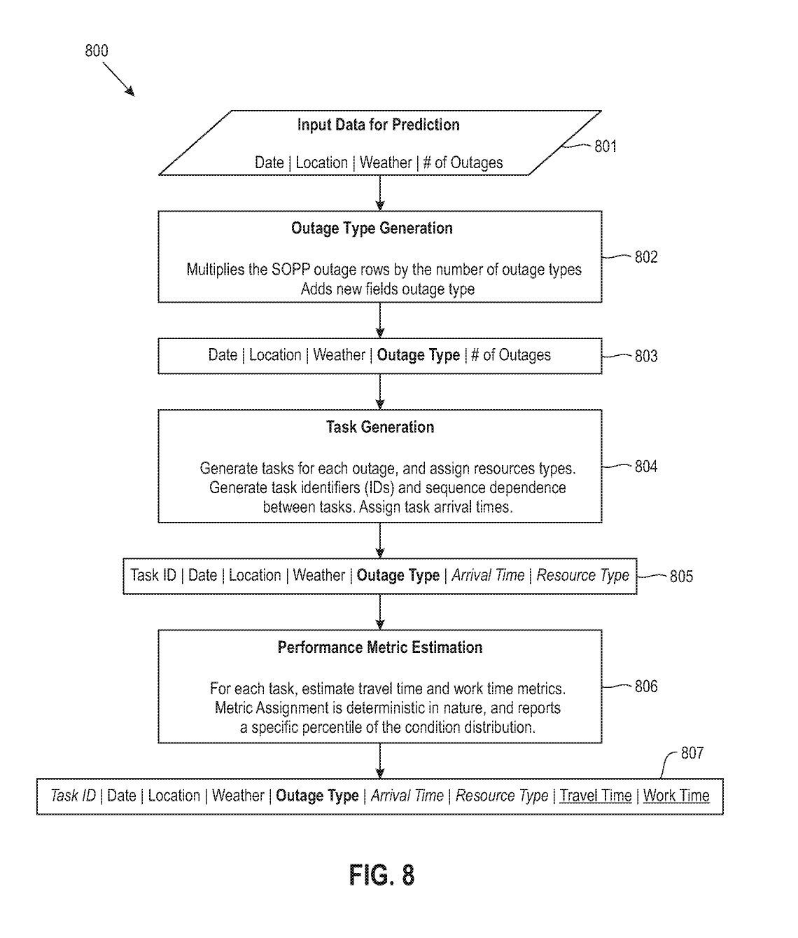

FIG. 8 depicts a flow 800 for estimation of response variables for a distributed service network comprising an electrical utility. It is to be appreciated, however, that embodiments are not limited to performing resource demand prediction for electrical or other utilities. The techniques described herein may be used in various other types of utilities and distributed service networks, including but not limited to telecommunications systems, distributed computing networks, “smart” cities, etc.

The flow 800 starts with input data used for prediction 801, which may include a table with columns for date, location, weather and number of outages. In block 802, outage type generation is performed by multiplying storm outage prediction model (SOPP) rows in the input data 801 by the number of outage types, and adds new fields for each row including the outage type as indicated by updated data 803. The outage type, which is an internal factor, is modeled using the location and weather information from the input data 801.

In block 804, task generation is performed by generating tasks for each outage and assigning resource types to each task. Task IDs are generated, along with sequence dependence between tasks. Arrival times for tasks are also assigned. The result is updated data 805, which includes columns for task ID, arrival time and resource type.

In block 806, performance metrics are estimated. For each task, travel time and work time metrics are estimated. Metric assignment may be deterministic in nature, and reports a specific percentile of the condition distribution. The result is updated data 807, which includes columns for travel time and work time. The processing flow 800 represents step by step resolution of various internal factors and final estimation of response variables in the sequence of computation graph.

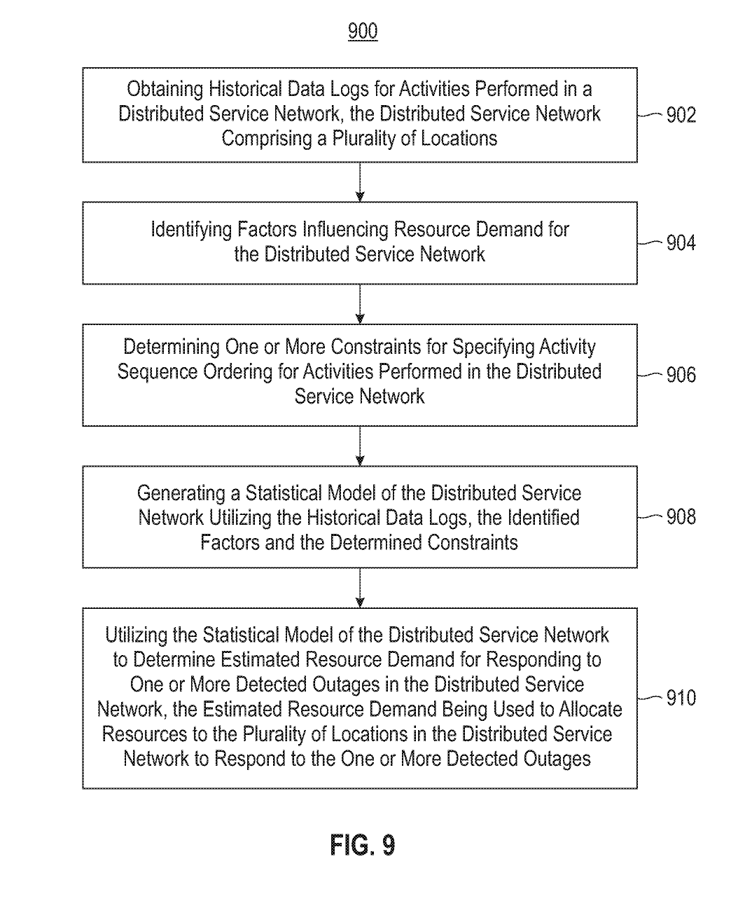

FIG. 9 depicts a process flow 900 for generating a statistical model of a distributed service network. The process flow begins with step 902, obtaining historical data logs for activities performed in a distributed service network, the distributed service network comprising a plurality of locations. In step 904, factors influencing demand for the distributed service network are identified. One or more constraints for specifying activity sequence ordering for activities performed in the distributed service network are determined in step 906. In step 908, a statistical model of the distributed service network is generated utilizing the historical data logs, the identified factors and the determined constraints. The process flow 900 continues with step 910, utilizing the statistical model of the distributed service network to determine estimated resource demand for responding to one or more detected outages in the distributed service network, the estimated resource demand being used to allocate resources to the plurality of locations in the distributed service network to respond to the one or more detected outages.

In some embodiments, step 908 includes creating a hierarchical prediction model for estimating effort for activities in the distributed service network. Creating the hierarchical prediction model may comprise computing association scores between each of the identified factors and associated resource demand, filtering the identified factors based at least in part on the association scores, ranking the identified factors based at least in part on the association scores, partitioning the historical data logs hierarchically based at least in part on the identified factors in accordance with the ranking, and learning a distribution model for resource demand at nodes in the hierarchy. Learning the distribution model for resource demand at nodes in the hierarchy may comprise, at each node in the hierarchy, deriving statistics from a parent node as prior. Each level of the hierarchy splits the historical log data by one or more specific factor values.

Step 908 in some embodiments may include creating an activity sequence model. Creating the activity sequence model may comprise utilizing the determined constraints to determine valid activity sequences for the distributed service network, processing the historical data logs to generate ordered sequences of activities using timestamps and outage identifiers, defining a stochastic sequence generator by inserting start and stop states for tasks, each task comprising one or more of the activities, the stochastic sequence generator comprising transition probabilities between states and activities obtained from the historical data logs, and utilizing the stochastic sequence generator to generate expected numbers of task and activity sequences for the distributed service network. The stochastic sequence generator may comprise a sequence generator Markov process.

Generating the statistical model in step 908 may include determining an ordering for evaluating the hierarchical prediction model, the activity sequence model, and estimating response variables. Determining the ordering may comprise defining a topological order of variable evaluation for the statistical model of the distributed service network. Step 910 may include invoking the hierarchical prediction model, the activity sequence model and response variable estimation in the determined ordering.

In some embodiments, step 908 comprises partitioning the historical log data into two or more data partitions each representing a distinct operational condition of the distributed service network. Partitioning the historical log data may comprise associating the identified factors for combinations of activity types and task types in the distributed service network, performing pairwise data partitioning for each of a set of factors having influence on resource demand in the distributed service network exceeding a first designated threshold, calculating response distributions for each of the data partitions, determining a subset of the set of factors having effects on resource demand in the distributed service network exceeding a second designated threshold based at least in part on the calculated response distributions, partitioning the historical data logs based at least in part on the determined subset of factors, and generating separate statistical models for the distributed service network for each of the partitions of the historical data logs.

In some embodiments, the historical data logs comprise a table with each of the rows comprising information used to model outage types for the distributed service network, and generating the statistical model of the distributed service network in step 908 comprises updating the table by multiplying rows of the historical data logs by the number of outage types and appending a new column for outage type. Step 908 may further include generating sequences of tasks and updating the table by appending new columns for resource types, task identifiers and task arrival times. Step 908 may also include estimating travel time and work time metrics for each task and updating the table by appending new columns for travel time and work time. In some embodiments, step 908 further includes utilizing the table as a computation graph to determine resource demand for the distributed service network.

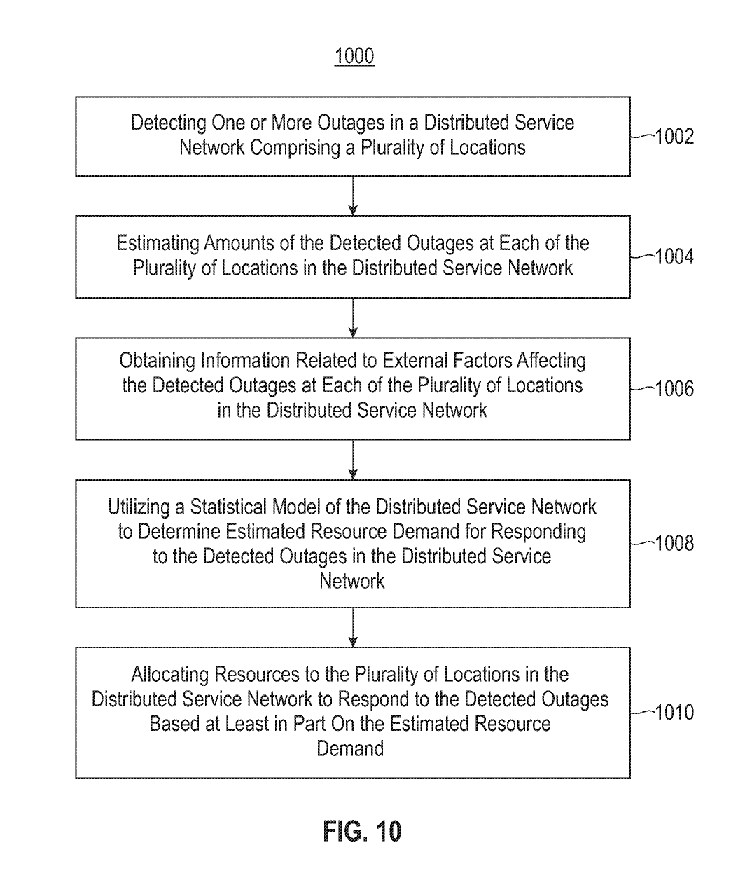

FIG. 10 depicts a process flow 1000 for estimating resource demand in a distributed service network utilizing a statistical model, such as a statistical model generating using process flow 900. The process flow 1000 begins with step 1002, detecting one or more outages in a distributed service network comprising a plurality of locations. In step 1004, amounts of the detected outages at each of the plurality of locations in the distributed service network are estimated. In step 1006, information relating to external factors affecting the detected outages at each of the plurality of locations in the distributed service network is obtained. In step 1008, a statistical model of the distributed service network is utilized to determine estimated resource demand for responding to the detected outages in the distributed service network. The process flow 1000 concludes with step 1010, allocating resources to the plurality of locations in the distributed service network to respond to the detected outages based at least in part on the estimated resource demand.

Embodiments provide various advantages relative to conventional techniques. For example, conventional approaches are not capable of modeling various scenarios, such as scenarios in which the total restoration time at a particular location is higher due to local transportation problems, and where there is very high initial response time or preparation time due to high demand in a particular area. Advantageously, embodiments can capture these and other types of variations explicitly by reading influencing factors out of log data. Embodiments also provide various advantages in statistically modeling variation in task and activity sequences, which affects resource allocation.

Embodiments provide processes for reading specific metadata and time logs of historical events, and utilizing modeling techniques such as HBM for estimating efforts associated with each activity by discovering influencing factors and factor ordering. Embodiments do not assume auto-regressive behavior in demand, and can thus handle both continuous and categorical feature values. Further, embodiments are agnostic of data sparsity, whereas conventional approaches are typically unable to handle sparse historical data since time-series analysis is not able to reliably handle data sparsity or missing data. Embodiments also provide advantages in supporting composite task definition, where a task may comprise various different activities that are modeled individually and then concatenated to form a specific task. Thus, embodiments are capable of modeling at a more granular level. Further, embodiments do not depend or rely upon the periodic nature of data, and hence there is no need for recent past data during estimation and scoring phases of modeling. Additional advantages are provided by external parameter modeling, such as activity and task modeling by learning sequences of activities. Further, effort estimations for each individual task (e.g., repair, assessment, etc.) may be done independently, rather than using a queuing network model where the modeling of tasks depends on the current state of the system. Since effort estimations for tasks are done independently in some embodiments, assumptions may be made that there are no interdependencies in demand estimate among tasks.

Embodiments provide further advantages in generating a model file that describes a variable dependency tree and a statistical model for each internal and response variable using Markov chains. Such features are possible due to the granular modeling capability of a task, where demand is estimated at the activity level and aggregated to derive demand at the task level. Conventional approaches that estimate effort at the task level directly have reduced accuracy. Additionally, granular modeling used in embodiments enables demand estimation even for partially observed data, which allows for generating demand estimates even during mid-event scenarios (e.g., in-storm planning). Granular modeling used in some embodiments is also capable of modeling multiple tasks corresponding to each event, outage or job. Thus, models used in some embodiments capture the heterogeneity in resource types and demand variation across different outages. This provides various advantages relative to conventional techniques which instead assume one task per event, outage or job. Additionally, given an event, outage or job, embodiments may generate multiple tasks using a Markov chain, as compared with conventional approaches which typically assume one task per event, outage or job.

Embodiments also provide advantages in segregating data into partitions, such that each data partition represents a distinct operational condition. Different models may be learned for each data partition. The generated model files can then be read and used to forecast resource demand. Embodiments thus provide for partitioning input data horizontally, learning distinct models for each partition or distinct operational condition. Each partition groups data with similar operational characteristics, which helps in deriving low variance demand prediction models.

Embodiments of the present invention include a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

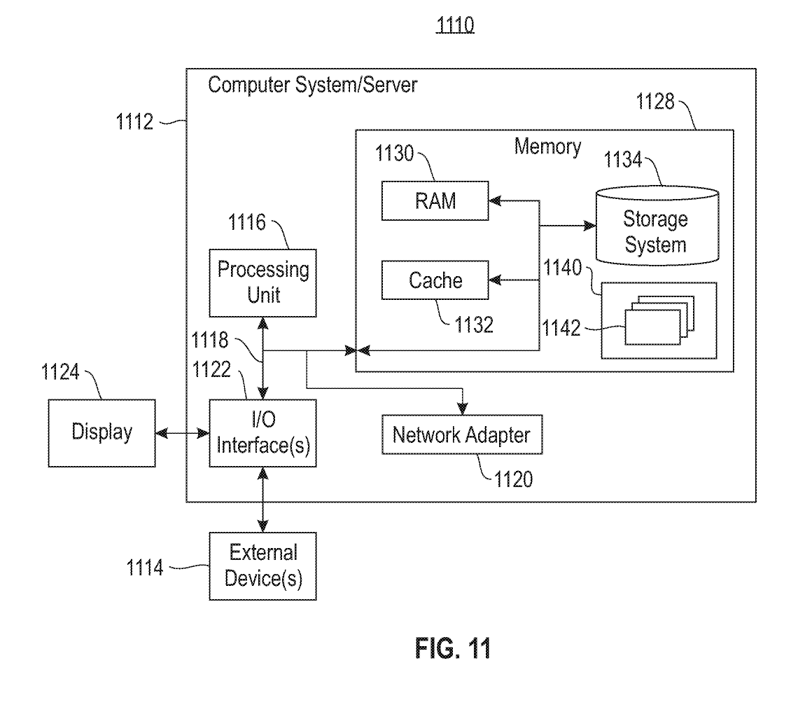

One or more embodiments can make use of software running on a general-purpose computer or workstation. With reference to FIG. 11, in a computing node 1110 there is a computer system/server 1112, which is operational with numerous other general purpose or special purpose computing system environments or configurations. Examples of well-known computing systems, environments, and/or configurations that may be suitable for use with computer system/server 1112 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, mobile and wearable devices, and distributed cloud computing environments that include any of the above systems or devices, and the like.

Computer system/server 1112 may be described in the general context of computer system executable instructions, such as program modules, being executed by a computer system. Generally, program modules may include routines, programs, objects, components, logic, data structures, and so on that perform particular tasks or implement particular abstract data types. Computer system/server 1112 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 11, computer system/server 1112 in computing node 1110 is shown in the form of a general-purpose computing device. The components of computer system/server 1112 may include, but are not limited to, one or more processors or processing units 1116, a system memory 1128, and a bus 1118 that couples various system components including system memory 1128 to processor 1116.

The bus 1118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system/server 1112 typically includes a variety of computer system readable media. Such media may be any available media that is accessible by computer system/server 1112, and it includes both volatile and non-volatile media, removable and non-removable media.

The system memory 1128 can include computer system readable media in the form of volatile memory, such as random access memory (RAM) 1130 and/or cache memory 1132. The computer system/server 1112 may further include other removable/non-removable, volatile/nonvolatile computer system storage media. By way of example only, storage system 1134 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 1118 by one or more data media interfaces. As depicted and described herein, the memory 1128 may include at least one program product having a set (e.g., at least one) of program modules that are configured to carry out the functions of embodiments of the invention. A program/utility 1140, having a set (at least one) of program modules 1142, may be stored in memory 1128 by way of example, and not limitation, as well as an operating system, one or more application programs, other program modules, and program data. Each of the operating system, one or more application programs, other program modules, and program data or some combination thereof, may include an implementation of a networking environment. Program modules 1142 generally carry out the functions and/or methodologies of embodiments of the invention as described herein.

Computer system/server 1112 may also communicate with one or more external devices 1114 such as a keyboard, a pointing device, a display 1124, etc., one or more devices that enable a user to interact with computer system/server 1112, and/or any devices (e.g., network card, modem, etc.) that enable computer system/server 1112 to communicate with one or more other computing devices. Such communication can occur via I/O interfaces 1122. Still yet, computer system/server 1112 can communicate with one or more networks such as a LAN, a general WAN, and/or a public network (e.g., the Internet) via network adapter 1120. As depicted, network adapter 1120 communicates with the other components of computer system/server 1112 via bus 1118. It should be understood that although not shown, other hardware and/or software components could be used in conjunction with computer system/server 1112. Examples include, but are not limited to, microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

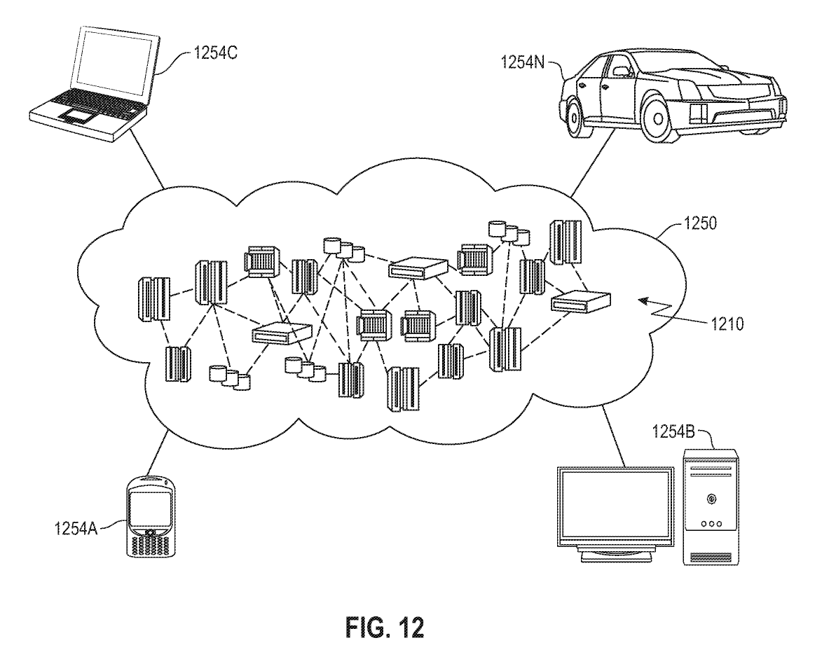

Referring now to FIG. 12, illustrative cloud computing environment 1250 is depicted. As shown, cloud computing environment 1250 includes one or more cloud computing nodes 1210 with which local computing devices used by cloud consumers, such as, for example, personal digital assistant (PDA) or cellular telephone 1254A, desktop computer 1254B, laptop computer 1254C, and/or automobile computer system 1254N may communicate. Nodes 1210 may communicate with one another. They may be grouped (not shown) physically or virtually, in one or more networks, such as Private, Community, Public, or Hybrid clouds as described hereinabove, or a combination thereof. This allows cloud computing environment 1250 to offer infrastructure, platforms and/or software as services for which a cloud consumer does not need to maintain resources on a local computing device. It is understood that the types of computing devices 1254A-N shown in FIG. 12 are intended to be illustrative only and that computing nodes 1210 and cloud computing environment 1250 can communicate with any type of computerized device over any type of network and/or network addressable connection (e.g., using a web browser).

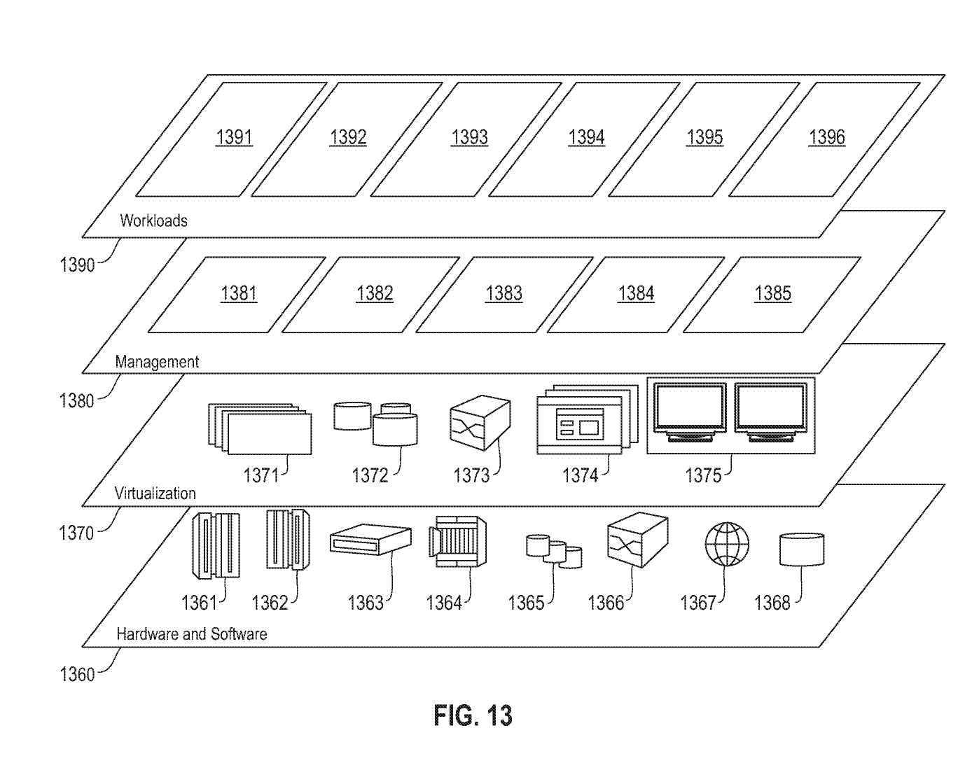

Referring now to FIG. 13, a set of functional abstraction layers provided by cloud computing environment 1250 (FIG. 12) is shown. It should be understood in advance that the components, layers, and functions shown in FIG. 13 are intended to be illustrative only and embodiments of the invention are not limited thereto. As depicted, the following layers and corresponding functions are provided:

Hardware and software layer 1360 includes hardware and software components. Examples of hardware components include: mainframes 1361; RISC (Reduced Instruction Set Computer) architecture based servers 1362; servers 1363; blade servers 1364; storage devices 1365; and networks and networking components 1366. In some embodiments, software components include network application server software 1367 and database software 1368.

Virtualization layer 1370 provides an abstraction layer from which the following examples of virtual entities may be provided: virtual servers 1371; virtual storage 1372; virtual networks 1373, including virtual private networks; virtual applications and operating systems 1834; and virtual clients 1375.

In one example, management layer 1380 may provide the functions described below. Resource provisioning 1381 provides dynamic procurement of computing resources and other resources that are utilized to perform tasks within the cloud computing environment. Metering and Pricing 1382 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1383 provides access to the cloud computing environment for consumers and system administrators. Service level management 1384 provides cloud computing resource allocation and management such that required service levels are met. Service Level Agreement (SLA) planning and fulfillment 1385 provide pre-arrangement for, and procurement of, cloud computing resources for which a future requirement is anticipated in accordance with an SLA.

Workloads layer 1390 provides examples of functionality for which the cloud computing environment may be utilized. Examples of workloads and functions which may be provided from this layer include: mapping and navigation 1391; software development and lifecycle management 1392; virtual classroom education delivery 1393; data analytics processing 1394; transaction processing 1395; and resource position processing 1396, which may perform various functions described above with respect to resource demand prediction and forecasting techniques described herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising steps of:
obtaining historical data logs for activities performed in a distributed service network, the distributed service network comprising a plurality of locations;
identifying factors influencing resource demand for the distributed service network;
determining one or more constraints for specifying activity sequence ordering for activities performed in the distributed service network;
generating a statistical model of the distributed service network utilizing the historical data logs, the identified factors and the determined constraints; and
utilizing the statistical model of the distributed service network to determine estimated resource demand for responding to one or more detected outages in the distributed service network, the estimated resource demand being used to allocate resources to the plurality of locations in the distributed service network to respond to the one or more detected outages;
wherein the steps are carried out by at least one processing device.

2. The method of claim 1, wherein generating the statistical model of the distributed service network comprises creating a hierarchical prediction model for estimating effort for activities in the distributed service network.

3. The method of claim 2, wherein creating the hierarchical prediction model comprises:
computing association scores between each of the identified factors and associated resource demand;
filtering the identified factors based at least in part on the association scores;
ranking the identified factors based at least in part on the association scores;
partitioning the historical data logs hierarchically based at least in part on the identified factors in accordance with the ranking; and
learning a distribution model for resource demand at nodes in the hierarchy.

4. The method of claim 3, wherein learning the distribution model for resource demand at nodes in the hierarchy comprises, at each node in the hierarchy, deriving statistics from a parent node as prior, and wherein each level of the splits the historical log data by one or more specific factor values.

5. The method of claim 2, wherein generating the statistical model of the distributed service network comprises creating an activity sequence model.

6. The method of claim 5, wherein creating the activity sequence model comprises:
utilizing the determined constraints to determine valid activity sequences for the distributed service network;
processing the historical data logs to generate ordered sequences of activities using timestamps and outage identifiers;
defining a stochastic sequence generator by inserting start and stop states for tasks, each task comprising one or more of the activities, the stochastic sequence generator comprising transition probabilities between states and activities obtained from the historical data logs; and
utilizing the stochastic sequence generator to generate expected numbers of task and activity sequences for the distributed service network.

7. The method of claim 6, wherein the stochastic sequence generator comprises a sequence generator Markov process.

8. The method of claim 5, wherein generating the statistical model of the distributed service network comprises determining an ordering for evaluating the hierarchical prediction model, the activity sequence model, and estimating response variables.

9. The method of claim 8, wherein determining the ordering comprises defining a topological order of variable evaluation for the statistical model of the distributed service network.

10. The method of claim 8, wherein utilizing the statistical model of the distributed service network determine estimated resource demand comprises invoking the hierarchical prediction model, the activity sequence model and response variable estimation in the determined ordering.

11. The method of claim 1, wherein generating the statistical model of the distributed service network comprises partitioning the historical log data into two or more data partitions each representing a distinct operational condition of the distributed service network.

12. The method of claim 11, wherein partitioning the historical log data comprises:
associating the identified factors for combinations of activity types and task types in the distributed service network;
performing pairwise data partitioning for each of a set of factors having influence on resource demand in the distributed service network exceeding a first designated threshold;
calculating response distributions for each of the data partitions;
determining a subset of the set of factors having effects on resource demand in the distributed service network exceeding a second designated threshold based at least in part on the calculated response distributions;
partitioning the historical data logs based at least in part on the determined subset of factors; and
generating separate statistical models for the distributed service network for each of the partitions of the historical data logs.

13. The method of claim 1 wherein the historical data logs comprise a table with each of the rows comprising information used to model outage types for the distributed service network, and wherein generating the statistical model of the distributed service network comprises updating the table by multiplying rows of the historical data logs by the number of outage types and appending a new column for outage type.

14. The method of claim 13, wherein generating the statistical model of the distributed service network comprises generating sequences of tasks and updating the table by appending new columns for resource types, task identifiers and task arrival times.

15. The method of claim 14, wherein generating the statistical model of the distributed service network comprises estimating travel time and work time metrics for each task and updating the table by appending new columns for travel time and work time.

16. The method of claim 15, wherein generating the statistical model of the distributed service network comprises utilizing the table as a computation graph to determine resource demand for the distributed service network.

17. A computer program product, the computer program product comprising a computer readable storage medium having program instructions embodied therewith, the program instructions executable by at least one computing device to cause the at least one computing device to perform steps of:
obtaining historical data logs for activities performed in a distributed service network, the distributed service network comprising a plurality of locations;
identifying factors influencing resource demand for the distributed service network;
determining one or more constraints for specifying activity sequence ordering for activities performed in the distributed service network;
generating a statistical model of the distributed service network utilizing the historical data logs, the identified factors and the determined constraints; and
utilizing the statistical model of the distributed service network to determine estimated resource demand for responding to one or more detected outages in the distributed service network, the estimated resource demand being used to allocate resources to the plurality of locations in the distributed service network to respond to the one or more detected outages.

18. A system comprising:
a memory; and
at least one processor coupled to the memory and configured for:
obtaining historical data logs for activities performed in a distributed service network, the distributed service network comprising a plurality of locations;
identifying factors influencing resource demand for the distributed service network;
determining one or more constraints for specifying activity sequence ordering for activities performed in the distributed service network;
generating a statistical model of the distributed service network utilizing the historical data logs, the identified factors and the determined constraints; and
utilizing the statistical model of the distributed service network to determine estimated resource demand for responding to one or more detected outages in the distributed service network, the estimated resource demand being used to allocate resources to the plurality of locations in the distributed service network to respond to the one or more detected outages.

19. A computer-implemented method, comprising steps of:
detecting one or more outages in a distributed service network comprising a plurality of locations;
estimating amounts of the detected outages at each of the plurality of locations in the distributed service network;
obtaining information related to external factors affecting the detected outages at each of the plurality of locations in the distributed service network;
utilizing a statistical model of the distributed service network to determine estimated resource demand for responding to the detected outages in the distributed service network; and
allocating resources to the plurality of locations in the distributed service network to respond to the detected outages based at least in part on the estimated resource demand;
wherein the steps are carried out by at least one processing device.

20. The method of claim 19, wherein the distributed service network comprises at least one of a utility, a telecommunications network and a distributed computing infrastructure.
